(19) United States
(12) Patent Application Publication
(10) Pub. No.: US 2010/0181298 A1
(43) Pub. Date: Jul. 22, 2010

(54) INDUCTION COIL, METHOD AND DEVICE FOR THE INDUCTIVE HEATING OF METAL COMPONENTS

(75) Inventors: Alexander Gindorf, Arnbach (DE); Herbert Hanrieder, Hohenkammer (DE); Hans Pappert, Kufstein (AT)

Correspondence Address: CROWELL & MORING LLP;INTELLECTUAL PROPERTY GROUP, P.O. BOX 14300, WASHINGTON, DC, 20044-4300, US

(73) Assignee: MTU AERO ENGINES GMBH, Munich (DE)

(21) Appl. No.: 12/664,288

(22) PCT Filed: May 17, 2008
(86) PCT No.: PCT/DE2008/000842

§ 371 Date: Dec. 11, 2009

(30) Foreign Application Priority Data
Jun. 14, 2007 (DE) 10 2007 027 327.6

(51) Int. Cl. B23K 13/01; H05B 6/36

(52) U.S. Cl. 219/617; 219/672

(57) ABSTRACT

An induction coil for use in a method for the inductive heating of metallic components, particularly components of a gas turbine, is disclosed. The coil includes at least two windings and the distance between the individual windings is configured such that the component or components to be heated can be inserted between two windings that are spaced apart from each other. A method and a device for the inductive heating of metallic components, particularly components of a gas turbine, and to a component produced by the method is also disclosed.

This application claims the priority of International Application No. PCT/DE2008/000842, filed May 17, 2008, and German Patent Document No. 10 2007 027 327.6, filed Jun. 14, 2007, the disclosures of which are expressly incorporated by reference herein.

### BACKGROUND AND SUMMARY OF THE INVENTION

The present invention relates to an induction coil for use in a method for the inductive heating of metallic components, particularly components of a gas turbine, comprising at least two windings. The invention further relates to a method and a device for the inductive heating of metallic components, particularly components of a gas turbine, and to a component produced by the method.

Another pressure welding method for connecting blade parts of a gas turbine is known from German Patent Document No. DE 198 58 702 A1, wherein a blade pan section and at least one other blade part are made available. In this case, corresponding connecting surfaces of these elements are essentially positioned aligned and spaced apart from one another and then welded to one another by exciting an inductor with high-frequency current and by moving them together with their connecting surfaces making contact. In the case of this inductive high-frequency pressure welding, the sufficiently great and homogeneous heating of the two welding mates is of crucial importance for the quality of the joint.

Additional inductive high-frequency pressure welding methods are known from European Patent Document Nos. EP 1 112 141 B1 and EP 1 140 417 B1. In this case, these methods are used to repair and manufacture an integrally bladed rotor for a turbo machine or are used in general to connect blade parts of a gas turbine. In this case, an inductor is used, which is arranged at a greater distance from the joining surface in the region of a forward blade edge and a rear blade edge than in the center region of the blade. As a result, the induced high-frequency electrical current is supposed to heat the front surface of the to-be-connected blade parts as uniformly as possible and allow only the regions near the front surface and/or near the surface to become molten.

Basically, in the case of methods for the inductive heating of metallic components, the problem arises that uniform heating of the to-be-processed and to-be-connected components can only be achieved with great difficulty independent of their cross sections. In addition, the thickness of the so-called heat impact zones should be kept as small as possible.

As a result, the objective of the present invention is making available a generic induction coil, in which uniform heating of metallic components is guaranteed independent of their cross sections while simultaneously reducing the heat impact zones.

Another objective of the present invention is making available a method for the inductive heating of metallic components, particularly components of a gas turbine, in which uniform heating of metallic components is guaranteed independent of their cross sections while simultaneously reducing the heat impact zones.

A further objective of the present invention is making available a device for the inductive heating of metallic components, particularly components of a gas turbine, in which uniform heating of metallic components is guaranteed independent of their cross sections while simultaneously reducing the heat impact zones.

An inventive induction coil for use in a method for the inductive heating of metallic components, particularly components of a gas turbine, comprises at least two windings, wherein the distance between the individual windings is configured such that the component or components to be heated can be inserted between two windings that are spaced apart from each other. Due to the inventive embodiment of the induction coil, at least one winding is situated above and one winding is situated below the to-be-processed component or to-be-processed components. In contrast, in the case of known induction coils, work takes place in the windings, i.e., the windings go around the component to be processed. The inventive induction coil allows the current flow to be guided so that it acts above the surfaces to be processed, such as, for example, the connecting surfaces of the components, and uniform heating of the entire processing or joining zone is thereby achieved independent of the cross section of the components. As a result, it is possible to work advantageously with very high power densities and a very short heating time, thereby considerably reducing the heat impact zone. In addition, because of the inventive induction coil and its corresponding arrangement with respect to the components, a scalable process can be achieved independent of the cross section of the component to be processed and based on the very targeted heat effect and the resulting low heat impact zone, better strength properties can be achieved in the welded connections for example. In addition, the inventive induction coil renders a heat input possible in surfaces with varying widths; in addition, the processed component can be retracted easily because the induction coil does not surround the component.

In an advantageous embodiment of the inventive induction coil, the distance between the individual windings is adapted to the geometry of the component or components to be inserted. As a result, uniform heating of the metallic components is guaranteed in a work area of the induction coil. In this case, for example, in a center region of the induction coil, the distance between the first and the second windings is greater than the distances in the edge regions of the induction coil.

In another advantageous embodiment of the induction coil, it is kept field-free in a work area. This can be achieved in that a transition from the first winding to the second is configured such that the current in the second winding flows in the opposite direction of the first winding. The transition forms a type of “hairpin turn” in the process. As a result, precise control of the application of heat in the work area is guaranteed.

In a further advantageous embodiment of the inventive induction coil, the coil features at least one cooling device. The cooling device guarantees that the induction coil itself does not start to melt or melt open.

In another advantageous embodiment of the inventive induction coil, the method for inductive heating is an inductive low-frequency or high-frequency pressure welding method for connecting metallic components, particularly components of a gas turbine. The frequencies used in this case may be selected from a range between 0.05-2.5 MHz. The inventive induction coil guarantees that the current flow acts above the connecting surfaces of the components to be connected and uniform heating of the entire joining zone is generated independent of the cross section of the components.

In further advantageous embodiments of the inventive induction coil, an isolator is arranged at least partially between at least one winding and the component or components in the region of the to-be-heated or to-be-connected sections of the components, wherein the isolator has at least one surface facing the component or components and is made of a material, which due to its specific properties, does not or does not substantially interfere with the magnetic interaction between the induction coil and the to-be-heated components. In addition, the surface of the isolator may be configured to be spaced apart from the windings and/or the component or components. The isolator may be made for example of glass, particularly of high temperature resistant quartz glass, a high temperature resistant ceramic or a high temperature resistant synthetic. The induction coil advantageously remains reliably insulated during the generation of metal vapor from the vaporization of the surfaces of the to-be-heated components, no plasma is generated and therefore no short circuit between the components and the induction coil. In addition, the process may be executed continuously and free of interference during metal vapor formation, something which is imperative for example in the case of the automatic series production of components. In addition, because of a suitable selection of material according to the invention, there is no interference with the magnetic interaction between the isolator and the components. A possible spacing of the surface of the isolator from the induction coil or from the individual windings and/or the component or components guarantees that warping does not occur between the induction coil and the isolator and/or the component and the isolator due to possible temperature-related differences in thermal expansion between these elements.

In other advantageous embodiments of the inventive induction coil, the isolator is configured to be layered or sheet-like. However, it is also possible for the isolator to be configured to be T-shaped, wherein an I-shaped base of the isolator is inserted into the winding, i.e., into the opening formed by the winding, and fastened in the winding, and the surface facing the component or components is configured to be approximately perpendicular to the base. The last-mentioned embodiment advantageously makes a secure and simple fixation of the isolator to the induction coil possible. The surface of the isolator facing the component or components may in turn be spaced apart from the winding.

In a further advantageous embodiment of the inventive induction coil, the geometry of the surface of the isolator facing the component or components is adapted to the geometry of the component or components to be inserted. This guarantees that there is no interference with the insertion of the component into the induction coil.

In another advantageous embodiment of the inventive induction coil, the isolator has at least one supply opening or supply line for the supply of an inert gas to the work area of the induction coil. This contributes to the quality of the heat treatment or the resulting welded connections.

An inventive method for the inductive heating of metallic components, particularly components of a gas turbine, comprises the following steps: a) providing one or more components to be heated; b) approach of at least one induction coil to the component or components or the approach of the component or components to the at least one induction coil, wherein the induction coil has at least two windings and the distance between the individual windings is configured such that the to-be-heated component or components can be inserted between two windings that are spaced apart from each other, and insertion of the to-be-heated component or components between the two windings that are spaced apart from each other; and c) inductive heating of the component or the components in a work area of the induction coil. The inventive method guarantees that uniform heating of the metallic components takes place independent of their cross sections while simultaneously producing a reduction in the heat impact zone. In contrast to the known methods for the inductive heating of metallic components, the inventive method operates between the windings of the induction coil, i.e., at least one winding is situated above and at least one winding is situated below the component or components to be processed. This results in a scalable process, which functions independently of the cross section of the component to be processed, wherein, because of the very targeted heat effect and the resulting small heat impact zone that is formed, better strength properties may be achieved particularly in the case of welded connections.

In an advantageous embodiment of the inventive method, the distance between the individual windings is adapted to the geometry of the component or components to be inserted. As a result, uniform heating of the to-be-processed regions of the metallic components is guaranteed. For example, a center region of the induction coil can have a greater distance between the first and second windings than the corresponding distances in the edge areas of the induction coil.

In another advantageous embodiment of the inventive method, the induction coil is kept field-free in a work area. This can be achieved for example in that a transition from the first winding to the second is configured such that the current in the second winding flows in the opposite direction of the first winding. The transition in this case is a type of “hairpin turn.” As a result, precise control of the heat input in the component or components is possible.

In a further advantageous embodiment of the inventive method, the inductive heating according to process step c) is an inductive low-frequency or high-frequency pressure welding method for connecting metallic components, particularly components of a gas turbine. The frequencies used in this case may be selected from a range between 0.05-2.5 MHz. However, it is also possible for the inductive heating according to process step c) to be configured as an inductive soldering for connecting metallic components or for eliminating the internal stress of metallic components. The inventive method makes possible a plurality of different application possibilities in the field of inductive heating of metallic components. In this case, for example, a first component can be a blade or a part of a blade of a rotor in a gas turbine and a second component can be a ring or a disk of the rotor or a blade root arranged on the circumference of the ring or the disk. However, the components may also be parts of a blade of a rotor in a gas turbine.

In another advantageous embodiment of the inventive method, in process step c) the heating of the component or components takes place in a temperature-controlled manner in the work area of the induction coil. The inventive method makes direct accessibility to the work area of the induction coil possible, for example the joining zone of two components. As a result, it is possible for pyrometer measurements to be taken for example, which may in turn be used as control variables in the method. This is crucially important for the stability of serial production processes in order to keep the structural formation of the to-be-processed components within narrow tolerances.

An inventive device for the inductive heating of metallic components, particularly components of a gas turbine, comprises at least one generator and at least one induction coil with at least two windings, wherein the distance between the individual windings is configured such that the component or components to be heated can be inserted between two windings that are spaced apart from each other. In contrast to common devices for inductive heating, processing or heating of the components takes place between the windings of the induction coil, i.e., at least one winding is situated above and at least one winding is situated below the components to be processed or joined. As a result, the current flow can be guided so that it acts above the to-be-processed surfaces or connecting surfaces and therefore uniform heating of the entire processing surface or joining zone is achieved independent of the cross section of the components. As a result, it is possible to work advantageously with very high power densities and a very short heating time, resulting in a great reduction of the heat impact zone as compared to the standard coil arrangement. The thickness of the heat impact zone is cut approximately in half.

In a further advantageous embodiment of the inventive device, the distance between the individual windings is adapted to the geometry the component or components to be inserted. In this case, it is possible, for example, for the center region of the induction coil to have a greater distance between the first and second windings than the corresponding distances in edge areas of the induction coil. Because of this adaptation, uniform heating of all to-be-processed surfaces is guaranteed in the work area of the induction coil.

In a further advantageous embodiment of the inventive device, the induction coil is kept field-free in a work area. This can be brought about for example in that a transition from the first winding to the second is configured such that the current in the second winding flows in the opposite direction of the first winding. The transition is configured in this case as a type of “hairpin turn.” As a result, precise control of the heat input in the component or components is possible.

In another advantageous embodiment, the induction coil features at least one cooling device. The cooling device guarantees that no damage occurs to the induction coil, for example, due to too great an application of heat to the induction coil.

In a further advantageous embodiment of the inventive device, the inductive heating is an inductive low-frequency or high-frequency pressure welding method for connecting metallic components, particularly components of a gas turbine. The frequencies used in this case may be selected from a range between 0.05-2.5 MHz. Because of the uniform heat input independent of the cross section of the components to be connected, the inventive device is particularly suited for connecting corresponding metallic components. In addition, the device may features means, which enable the inductive low-frequency or high-frequency pressure welding method to be carried out in a vacuum or in a protective gas atmosphere. This contributes to the quality of the resulting welded connections.

In further advantageous embodiments of the inventive device, an isolator is arranged at least partially between at least one winding and the component or components in the region of the to-be-heated or to-be-connected sections of the components, wherein the isolator has at least one surface facing the component or components and is made of a material, which due to its specific properties, does not or does not substantially interfere with the magnetic interaction between the induction coil and the to-be-heated components. In addition, the surface of the isolator may be configured to be spaced apart from the windings and/or the component or components. The isolator may be made for example of glass, particularly of high temperature resistant quartz glass, a high temperature resistant ceramic or a high temperature resistant synthetic. With the device, the induction coil advantageously remains reliably insulated during the generation of metal vapor from the vaporization of the surfaces of the to-be-heated components, no plasma is generated and therefore no short circuit between the components and the induction coil. In addition, the device is also able to continue to work continuously and free of interference during metal vapor formation, something which is imperative for example in the case of the automatic series production of components. In addition, because of a suitable selection of material according to the invention, there is no interference with the magnetic interaction between the isolator and the components. A possible spacing of the surface of the isolator from the induction coil or from the individual windings and/or the component or components guarantees that warping does not occur between the induction coil and the isolator and/or the component and the isolator due to possible temperature-related differences in thermal expansion between these elements.

In other advantageous embodiments of the inventive device, the isolator is configured to be layered or sheet-like. However, it is also possible for the isolator to be configured to be T-shaped, wherein an I-shaped base of the isolator is inserted into the winding, i.e., in the opening formed by the winding, and is fastened in the winding, and the surface facing the component or components is configured to be approximately perpendicular to the base. The last-mentioned embodiment advantageously makes a secure and simple fixation of the isolator to the induction coil possible. The surface of the isolator facing the component or components may in turn be spaced apart from the winding.

In another advantageous embodiment of the inventive device, the geometry of the surface of the isolator facing the component or components is adapted to the geometry of the component or components to be inserted. This guarantees that there is no interference with the insertion of the component into the induction coil.

In a further advantageous embodiment of the inventive device, the isolator has at least one supply opening or supply line for the supply of an inert gas to the work area of the induction coil. This contributes to the quality of the heat treatment or the resulting welded connections.

In another advantageous embodiment of the inventive device, the device features means for measuring and controlling the temperature in the region of the component or components to be processed. The measured values can be used in this case as control variables for the method for the inductive heating of metallic components thereby realizing a temperature-controlled process. As a result, it is possible for the inventive device to be used for so-called serial production processes.

Additional advantages, features and details of the invention are disclosed in the following description of a graphically depicted exemplary embodiment.

### BRIEF DESCRIPTION OF THE DRAWINGS

FIG. 1 is a schematic representation of an inventive induction coil;

FIG. 2 is a schematic representation of the inventive induction coil according to FIG. 1 with isolators arranged;

FIG. 3 is a further schematic representation of the inventive induction coil according to FIG. 2;

FIG. 4 is a schematic representation of an inventive device for the inductive heating of metallic components; and

FIG. 5 is a device according to FIG. 4, wherein the components to be joined are situated in the coil arrangement.

### DETAILED DESCRIPTION OF THE DRAWINGS

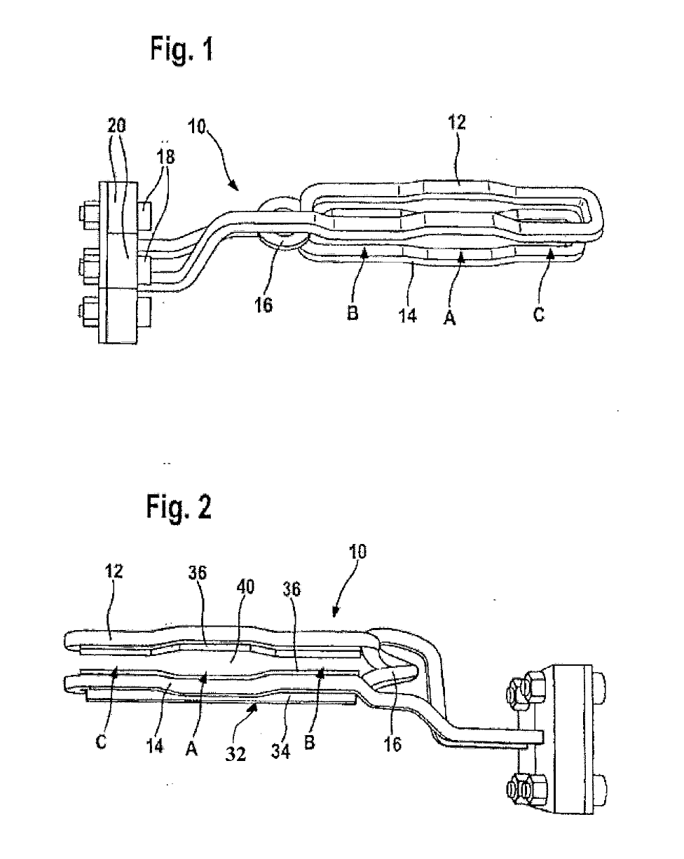

FIG. 1 shows a schematic representation of an induction coil 10. The induction coil 10 is used in this case in a method for the inductive heating of metallic components, particularly components of a gas turbine. One can see that the induction coil 10 has two windings 12, 14, wherein the distance A, B, C between the windings 12, 14 is configured such that the component or components to be heated can be inserted between the two windings 12, 14 that are spaced apart from each other. In order to make it easier to insert the components and to guarantee uniform heating of the inserted components, the distance A, B, C between the individual windings 12, 14 is adapted to the geometry of the components 28, 30 to be inserted (also see FIG. 2). One sees that in a center region of the induction coil 10, the distance A between the first and the second winding 12, 14 is greater than the distances B, C in the edge areas of the induction coil 10. In addition, one can see that a transition 16 from the first winding 12 to the second winding 14 is configured as a type of “hairpin turn” so that the current in the second winding 14 flows in the opposite direction of the first winding 12.

Fastening means 18 are used to fasten the induction coil 10 or the coil bases 20 to a housing of a device 22 (also see FIG. 2). The induction coil 10 is normally comprised of copper or a copper alloy. Other metals or metal alloys may also be used.

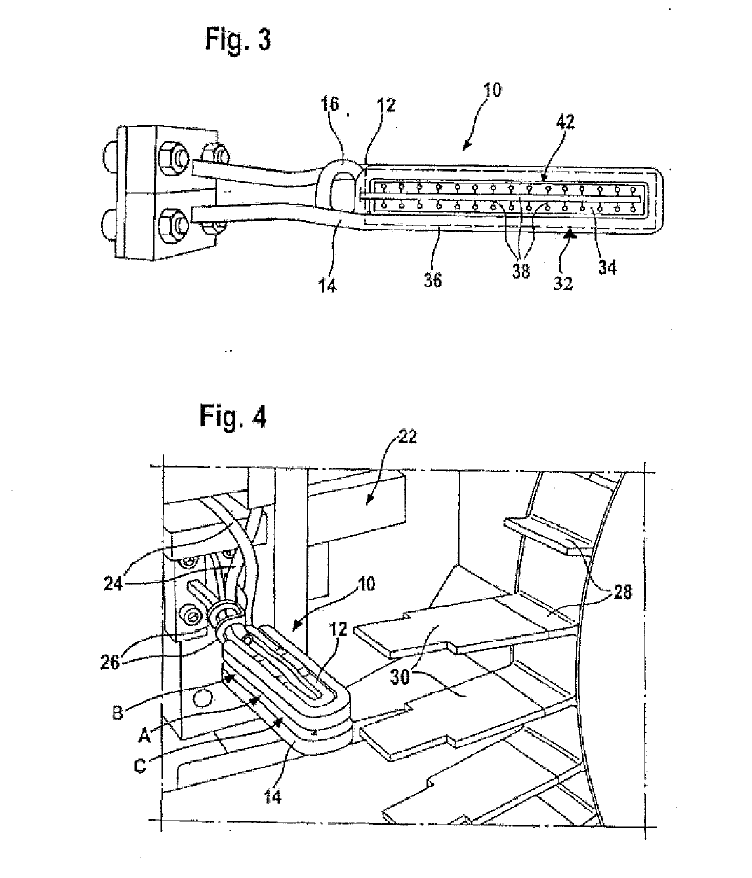

FIG. 2 depicts a schematic representation of the induction coil 10 according to FIG. 1 with isolators 32 arranged. One can see that a respective isolator 32 is arranged between the windings 12, 14 and an insertion opening 40 defined by the distances A, B, C of the two windings 12, 14 from one another for the component or components 28, 30 or between the windings 12, 14 and the component or components 28, 30 in the region of the to-be-heated or to-be-connected sections of the components 28, 30. The isolator 32 in this case has a surface 36 facing the component or components 28, 30 or the insertion opening 40. In the depicted exemplary embodiment, the isolators 32 are configured to be T-shaped, wherein an T-shaped base 34 of the respective isolator 32 is inserted into the corresponding winding 12, 14 or into an opening 42 (also see FIG. 3) formed by the winding 12, 14 and is fastened in the winding 12, 14. The surface 36 in this case is approximately perpendicular to the base 34. In addition, one can see that the geometry of the surface 36 of the isolator 32 facing the component or components 28, 30 is adapted to the geometry of the component or components 28, 30 to be inserted and also to the geometry of the windings 12, 14 in this region.

The isolator is made of a material, which due to its specific properties, does not or does not substantially interfere with the magnetic interaction between the induction coil 10 and the to-be-heated or to-be-connected components 28, 30. In particular, the isolator 32 may be made of glass, particularly of high temperature resistant quartz glass, a high temperature resistant ceramic or a high temperature resistant synthetic.

FIG. 3 shows a further schematic representation of the induction coil according to FIG. 2. One can see the T-shaped embodiment of the isolators 32 as well as their fastening in the openings 42 of the windings 12, 14. In addition, it is clear that the isolators 32 have supply openings or supply lines 38 for the supply of an inert gas to the work area of the induction coil 10.

FIG. 4 depicts a schematic representation of the device 22 for the inductive heating of metallic components. One can see that the components 28, 30 are a blade root as well as a blade pan of a rotor of a gas turbine. In this case, the blade pan 30 is connected to the blade root 28 by means of an inductive high-frequency pressure welding method. In order to achieve this, the joining zone of the components 28, 30 is guided between the windings 12, 14 of the induction coil 10. This is accomplished either by the induction coil 10 approaching the joining zone of the components 28, 30 or by correspondingly inserting the components 28, 30 into the work area of the induction coil 10, namely into the region between the first and second windings 12, 14.

In addition, one can see the tubular gas leads 24, which channel the protective gas into the region of the windings 12, 14 of the induction coil 10 in order to completely surround the joining region with the inert protective gas by means of a protective gas shower and therefore uncouple it from the ambient atmosphere. Finally, several rings 26 embodied of magnetic material are arranged on the induction coil 10, which increase the heating effect of the inductor 10 because they concentrate the coupled-in magnetic flux.

The exemplary embodiment makes clear that the device 22 is suitable both for the manufacture as well as the repair of components and structural elements of a gas turbine.

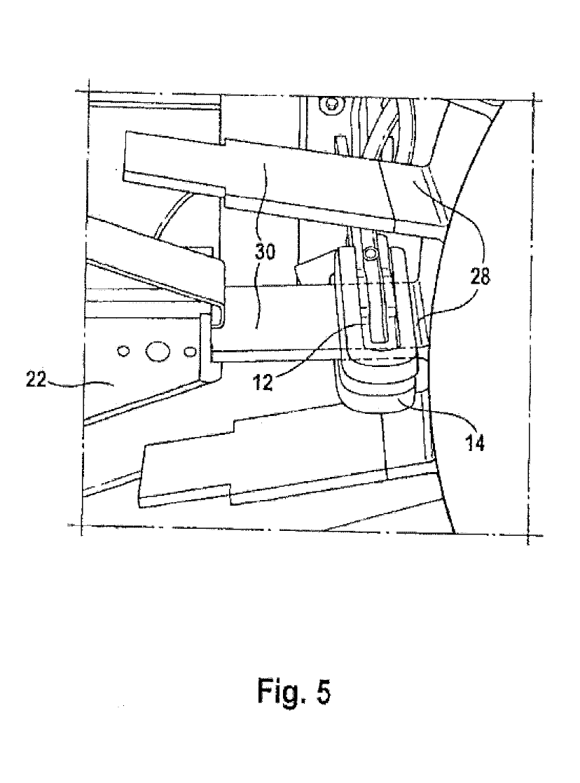

FIG. 5 shows the device 22 that was already depicted in FIG. 4, wherein in this case the blade pan 30 and the blade root 28 are still situated between the windings 12, 14. It is clear to see that the winding 12 is situated completely above the components 30, 28, while the winding 14 (in this case wrapped in insulating material) is situated beneath the component 28, 30. Thus, the individual windings 12, 14 do not surround the joining surface of the components 28, 30; rather, they are situated respectively on either side of the joining surface. As a result, it is also guaranteed that the coil arrangement with both windings 12, 14 can be moved out to the side relative to the joined components 28, 30; complicated unthreading is eliminated.

1-39. (canceled)

40. An induction coil for an inductive low-frequency or high-frequency pressure welding method for connecting metallic components, comprising:
a first winding and a second winding wherein a distance between the first and second windings is configured such that a component to be heated is insertable between the first and second windings and wherein the distance between the first and second windings is adapted to a geometry of the component to be inserted.

41. The induction coil according to claim 40, wherein in a center region of the induction coil a distance between the first and second windings is greater than a distance in edge regions of the induction coil.

42. The induction coil according to claim 40, wherein the induction coil is kept field-free in a work area.

43. The induction coil according to claim 42, wherein a transition from the first winding to the second winding is configured such that a current in the second winding flows in an opposite direction than a current in the first winding.

44. The induction coil according to claim 40, wherein the induction coil includes a cooling device.

45. The induction coil according to claim 40, wherein frequencies used in the inductive low-frequency or high-frequency pressure welding method are selected from a range between 0.05-2.5 MHz.

46. The induction coil according to claim 40, further comprising an isolator arranged at least partially between at least one of the first and second windings and the component in a region of a to-be-heated or to-be-connected section of the component, wherein the isolator has a surface facing the component and is made of a material, which due to its specific properties, does not or does not substantially interfere with a magnetic interaction between the induction coil and the to-be-heated component.

47. The induction coil according to claim 46, wherein the surface of the isolator is spaced apart from the at least one of the first and second windings and/or the component.

48. The induction coil according to claim 46, wherein the isolator is layered or sheet-like.

49. The induction coil according to claim 46, wherein the isolator is T-shaped, wherein an I-shaped base of the isolator is inserted into one of the first and second windings and fastened in the one of the first and second windings, and wherein the surface is approximately perpendicular to the base.

50. The induction coil according to claim 46, wherein a geometry of the surface of the isolator facing the component is adapted to a geometry of the component to be inserted.

51. The induction coil according to claim 46, wherein the isolator is made of glass, a high temperature resistant ceramic, or a high temperature resistant synthetic.

52. The induction coil according to claim 46, wherein the isolator has a supply opening or a supply line for a supply of an inert gas to a work area of the induction coil.

53. A method for inductive heating of metallic components, comprising the steps of:
providing components to be heated;
inserting the to-be-heated components between a first winding and a second winding of an induction coil, wherein the first winding and the second winding are spaced apart from each other; and
inductive heating of the to-be-heated components in a work area of the induction coil, wherein the inductive heating is an inductive low-frequency or high-frequency pressure welding method for connecting metallic components and wherein a distance between the first and second windings is adapted to a geometry of the to-be-heated components.

54. The method according to claim 53, wherein in a center region of the induction coil a distance between the first winding and the second winding is greater than a distance in edge regions of the induction coil.

55. The method according to claim 53, wherein the induction coil is kept field-free in a work area.

56. The method according to claim 53, wherein a transition from the first winding to the second winding is configured such that a current in the second winding flows in an opposite direction than a current in the first winding.

57. The method according to claim 53, wherein frequencies used in the inductive low-frequency or high-frequency pressure welding method are selected from a range between 0.05-2.5 MHz.

58. The method according to claim 53, wherein the step of inductive heating is an inductive soldering.

59. The method according to claim 53, wherein the step of inductive heating eliminates an internal stress in the components.

60. The method according to claim 53, wherein a one of the components is a blade or a part of a blade of a rotor in a gas turbine and another of the components is a ring or a disk of the rotor or a blade root arranged on a circumference of the ring or the disk.

61. The method according to claim 53, wherein the components are parts of a blade of a rotor in a gas turbine.

62. The method according to claim 53, wherein in the step of inductive heating the heating of the components takes place in a temperature-controlled manner in the work area of the induction coil.

63. A device for inductive heating of metallic components, comprising:
a generator; and
an induction coil with a first winding and a second winding, wherein the induction coil is coupled to the generator;
wherein the inductive heating is an inductive low-frequency or high-frequency pressure welding method for connecting metallic components, wherein a distance between the first winding and the second winding is configured such that a component to be heated is insertable between the first winding and the second winding, and wherein a distance between the first winding and the second winding is adapted to a geometry of the component to be inserted.

64. The device according to claim 63, wherein in a center region of the induction coil a distance between the first winding and the second winding is greater than a distance in edge regions of the induction coil.

65. The device according to claim 63, wherein the induction coil is kept field-free in a work area.

66. The device according to claim 63, wherein a transition from the first winding to the second winding is configured such that a current in the second winding flows in an opposite direction than a current in the first winding.

67. The device according to claim 63, wherein the induction coil includes a cooling device.

68. The device according to claim 63, wherein frequencies used in the inductive low-frequency or high-frequency pressure welding method are selected from a range between 0.05-2.5 MHz.

69. The device according to claim 63, further comprising means for carrying out the inductive low-frequency or high-frequency pressure welding method in a vacuum or in a protective gas atmosphere.

70. The device according to claim 63, further comprising an isolator arranged at least partially between at least one of the first and second windings and the component in a region of a to-be-heated or to-be-connected section of the component, wherein the isolator has a surface facing the component and is made of a material, which due to its specific properties, does not or does not substantially interfere with a magnetic interaction between the induction coil and the to-be-heated component.

71. The device according to claim 70, wherein the surface of the isolator is spaced apart from the at least one of the first and second windings and/or the component.

72. The device according to claim 70, wherein the isolator is layered or sheet-like.

73. The device according to claim 70, wherein the isolator is T-shaped, wherein an I-shaped base of the isolator is inserted into one of the first and second windings and fastened in the one of the first and second windings, and wherein the surface is approximately perpendicular to the base.

74. The device according to claim 70, wherein a geometry of the surface of the isolator facing the component is adapted to a geometry of the component to be inserted.

75. The device according to claim 70, wherein the isolator is made of glass, a high temperature resistant ceramic, or a high temperature resistant synthetic.

76. The device according to claim 70, wherein the isolator has a supply opening or a supply line for a supply of an inert gas to a work area of the induction coil.

77. The device according to claim 63, wherein further comprising means for measuring and controlling a temperature in a region of the component.

78. A component produced in accordance with a method according to claim 53, wherein the component is a BLING or BLISK.
